(19) United States
(12) Patent Application Publication
(10) Pub. No.: US 2024/0214228 A1
(43) Pub. Date: Jun. 27, 2024

(54) BLOCKCHAIN BASED PUBLIC KEY INFRASTRUCTURE

(71) Applicant: VMware, Inc., Palo Alto, CA (US)

(72) Inventor: Sean James Huntley, Sydney (AU)

(21) Appl. No.: 18/087,437

(22) Filed: Dec. 22, 2022

(51) Int. Cl. H04L 9/00; H04L 9/30; H04L 9/32

(52) U.S. Cl. CPC H04L 9/50; H04L 9/30; H04L 9/3247

(57) ABSTRACT

Disclosed are various embodiments for blockchain based public key infrastructure. A public key associated with a network address and an identifier of a certifying smart contract for a certifying entity associated with the public key can be obtained from an identity smart contract hosted by a blockchain network. Then, a certifying public key and a signature for the public key associated with the network address are obtained from the certifying smart contract. Subsequently, the signature of the public key associated with the network address can be verified using the certifying public key.

BACKGROUND

Certificate authorities and public key services are regularly used to verify the integrity, authenticity, security, and distribution of cryptographic certificates and cryptographic public keys. Applications can send requests for public keys to certificate authorities or public key services, but must trust that the certificate authority or public key service has adequately verified the authenticity of the public key it provides, including confirming the identity of the owner of the respective private key. However, many applications are unable to independently verify the trustworthiness of the certificate authority or public key service.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing depicting one of several embodiments of the present disclosure.

FIG. 1B is a drawing depicting one of several embodiments of the present disclosure.

FIG. 2 is a drawing of a network environment according to various embodiments of the present disclosure.

FIG. 3 is a flowchart illustrating one example of functionality implemented as portions of an application executed in in the network environment of FIG. 2 according to various embodiments of the present disclosure.

FIG. 4 is a drawing depicting one of several embodiments of the present disclosure.

FIG. 5 is a flowchart illustrating one example of functionality implemented as portions of an application executed in in the network environment of FIG. 2 according to various embodiments of the present disclosure.

FIG. 6 is a flowchart illustrating one example of functionality implemented as portions of an application executed in the network environment of FIG. 2 according to various embodiments of the present disclosure.

### DETAILED DESCRIPTION

Disclosed are various approaches for implementing a blockchain based public key infrastructure. Public key information is stored or hosted on a blockchain maintained by a blockchain network. Client devices can retrieve public key information in order to use the public key to communicate with another device, virtual machine, or application. In order to determine whether the public key stored on the blockchain can be trusted, certifying smart contracts can be queried to determine whether the public key has been signed by a trusted certifying entity. Certifying contracts can be recursively queried until a trusted certifying smart contract is located or identified, at which point a chain of trust can be established between the public key and the trusted certifying entity.

The various embodiments of the present disclosure have a number of improvements over traditional public key infrastructure. First, key revocations can be handled publicly and transparently with global visibility. Second, one is not required to trust a certifying entities by default, but can search for a trusted certifying entity on the blockchain to use as an anchor to evaluate the trustworthiness of individual public keys or individual certifying entities. Other improvements over traditional public key infrastructure will also become apparent from a review of the various embodiments of the present disclosure.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

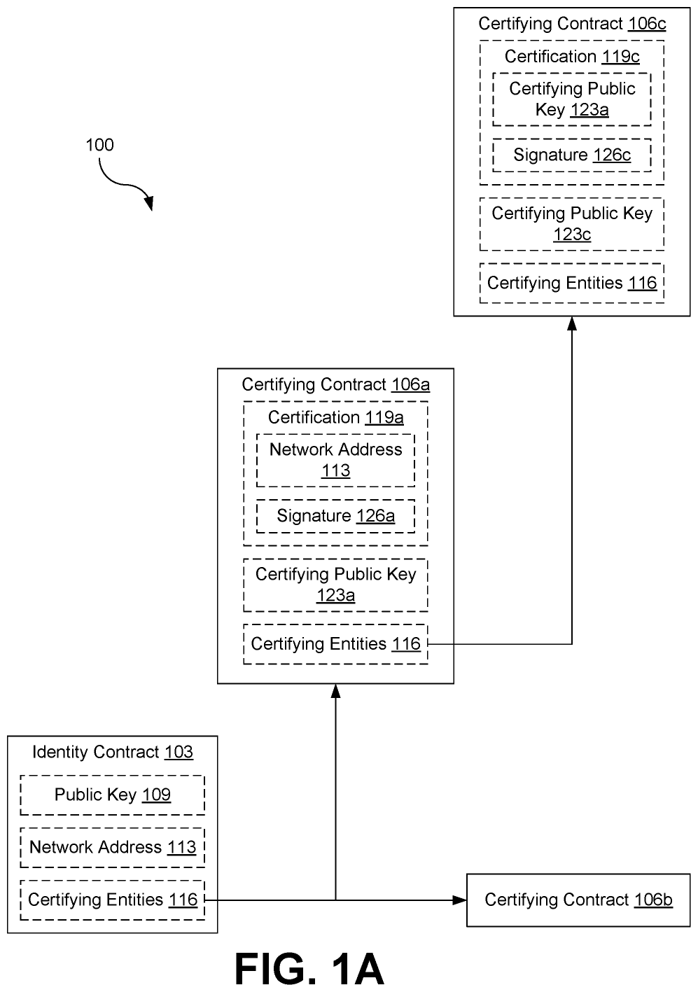

FIG. 1A illustrates a blockchain network 100a according to various embodiments of the present disclosure. A blockchain network 100, such as the blockchain network 100a, can host a variety of smart contracts, such as an identity contract 103, and one or more certifying contracts 106 (e.g., certifying contracts 106a, 106b, and 106c). A smart contract can represent executable computer code that can be executed by a node of a blockchain network 100. In many implementations, a smart contract can expose one or more functions that can be called by any user or by a limited set of users. To execute one or more functions of a smart contract, an application or another smart contract, can submit a request to a node of a blockchain network 100 to execute the function. The node can then execute the function and either return the result to the application or store the resulting change in the state of a blockchain network 100 to the blockchain network 100. Nodes may charge fees in the form of cryptocurrency coins or tokens to execute a function and store the output, with more complicate or extensive functions requiring larger fees. An example of this implementation is the ETHEREUM blockchain network, where users can pay fees, referred to as “gas,” in order to have a node of the ETHEREUM blockchain network execute the function and store the result to the ETHEREUM blockchain. Additionally, the more “gas” a user pays, the more quickly the function will be executed, and its results committed to the ETHEREUM blockchain.

An identity contract 103 can represent a smart contract which stores and provides information about an individual public key 109. Information stored by the identity contract 103 can include the public key 109 itself, a network address 113 associated with the public key 109, and one or more certifying entities 116. The identity contract 103 can also expose or otherwise provide publicly available functions that can be called or otherwise invoked in order to request the public key 109, network address 113, and/or certifying entities 116. The public key 109 can represent the public key of a respective private key controlled by the owner or operator of the network address 113. The network address 113 can represent the network endpoint of an application that uses the public key 109 and respective private key. Examples of network addresses 113 include domain name service (DNS) fully-qualified domain names (FQDNs), internet protocol (IP) addresses, or other types of identifiers. The certifying entities 116 can represent a list of one or more blockchain addresses for one or more respective certifying contracts 106 (e.g., certifying contract 106a and/or certifying contract 106b) which attest to the accuracy or validity of information provided by the identity contract 103, such as whether the public key 109 is a valid public key for use with services or applications hosted at the network address 113.

Many different types of blockchain addresses can be used in the various embodiments of the present disclosure. For example, wallet addresses derived from the respective public key of a private key of a user or application could be used as a blockchain address. As another example, blockchain name services such as the ETHEREUM Name Service (ENS) could be used as blockchain addresses to locate individual smart contracts such as identity smart contracts 103 or certifying smart contracts 106.

A certifying contract 106 can represent a smart contract of a certifying authority, service, or agency that stores and provides information regarding the veracity and authenticity of the information stored in an identity contract 103 or another certifying contract 106. Accordingly, a certifying contract 106 could include one or more certifications 119, a certifying public key 123, and/or a list of certifying entities 116.

A certification 119 can represent an assertion by the certifying contract 106 that the data signed by the respective private key of the certifying public key 123 of the certifying contract 106 can be trusted. For example, a certification 119a could include the public key 109 stored by the identity contract 103 (or an identifier for the public key 109) and a signature 126a for the public key 109 stored by the identity contract 103. Therefore, the certification 119a could represent an assertion by the certifying contract 106a that the respective public key 109 for the network address 113 is a currently valid key (e.g., because ownership of the respective private key has been verified by the operator of the certifying contract 106a). As another example, a certification 119, such as certification 119c could include a certifying public key 123 (or an identifier for a certifying public key 123) and a signature 126, such as where the certification 119c stored in the certifying contract 106c includes the certifying public key 123a and the signature 126c. In this example, the certification 119c could represent an assertion by the certifying contract 106c that certifications 119a made by the certifying contract 106a can be trusted because ownership of the respective private key for the certifying public key 123a has been verified by the operator of the certifying contract 106c and/or the verification practices of the operator of the certifying contract 106a have been verified by and met the satisfaction of the operator of the certifying contract 106c.

A certifying public key 123 can represent the respective public key of the private key of the operator of the certifying contract 106. The certifying public key 123 can be used to verify signatures 126 generated by the operator of the certifying contract 106.

The certifying entities 116 in a certifying contract 106 identify other certifying contracts 106 which have attested to the accuracy or validity of information provided by the certifying contract 106. For example, certifying contract 106a could include in its list of certifying entities 116 a reference to the blockchain address of the certifying contract 106c. This would act as an assertion that the operator of the certifying contract 106c trusts the operator of the certifying contract 106a to make true and accurate certifications 119.

As discussed in further detail later, the web of identity contracts 103 and certifying contracts 106 can allow for distribution, verification, and validation of public keys to occur in a decentralized and distributed manner. If one wishes to obtain the public key 109 for a website, one could send a request for the public key 109 to the identity contract 103 with a network address 113 that matches the FQDN or IP address of the website. In order to verify that the public key 109 for the website is the correct public key 109, one could request the list of certifying entities 116 to obtain the identities of the certifying contract(s) 106 that have verified the public key 109 returned by the identity contract 103, such as certifying contracts 106a and 106b. If one or more of the certifying contracts 106 were trusted, then the signature 126 in a certification 119 for the public key 109 could be requested. If a matching certification 119 is identified and a signature 126 for the public key 109 is returned, then the public key 109 could be validated or verified based at least in part on the signature 126. However, if none of the certifying contracts 106 are trusted, then the list of certifying entities 116 of individual certifying contracts 106 could be queried to obtain the identities of additional certifying contracts 106 (e.g., certifying contract 106c). If one of the additional certifying contracts 106 (e.g., certifying contract 106c) were trusted, then a certification 119 (e.g., certification 119c) could be evaluated to determine whether an earlier certifying contract 106 (e.g., certifying contract 106a) could be trusted to verify the public key 109 provided by the identity contract 103. A more detailed description of this process is provided in the discussion accompanying the later figures.

FIG. 1B depicts a blockchain network 100b with an alternative implementation of the identity contract 103. In the blockchain network 100b, a single identity contract 103 could store multiple identity records 129. Each identity record 129 could represent a public key 109 associated with a network address 113, and each identity record 129 could include a list of certifying entities 116 that have certified the public key 109 for the network address 113 as previously described in the discussion of FIG. 1A. The identity contract of FIG. 1B could provide the information of individual identity records 129 in response to queries received from other devices or applications. In contrast to implementations such as those illustrated by FIG. 1A, where each network address 113 or public key 109 could have its own identity contract 103, the identity contract 103 of FIG. 1B could be used for multiple network addresses 113 or public keys 109. For example, an organization or enterprise could use the identity contract 103 of FIG. 1B to store identity records 129 for all of the public keys 109 used by the services at respective network addresses 113 under the control of the organization.

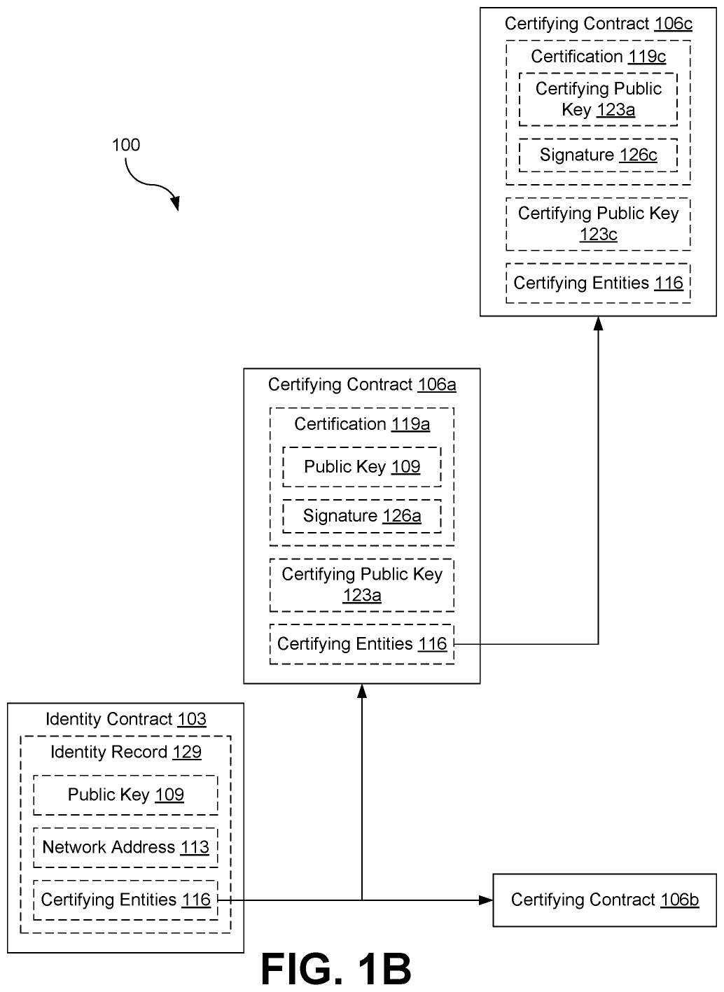

With reference to FIG. 2, shown is a network environment 200 according to various embodiments. The network environment 200 can include one or more host machines 201, one or more management devices 203, one or more client devices 206, and a blockchain network 100, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The host machine 201 and/or the management device 203 can represent any physical or virtualized computing device that includes a processor, a memory, and/or a network interface. For example, the host machine and/or the management device 203 could represent a computing device located in a datacenter, computing cluster, etc. Likewise, the host machine 201 and/or the management device 203 could be deployed as virtual machine or container.

Various applications or other functionality can be executed by the host machine 201, which are collectively and/or generically referred to as a hosted service 211. Examples of hosted services 211 include web services or applications, messaging services or applications, file storage or transfer services or applications, etc. To communicate with the hosted service 211, other computing devices could send messages, queries, commands, requests, etc. to a network address 113 of the host machine 201. To secure communications with the hosted service 211, a public key 109 could be issued by a key management service 213 to the host machine 201. Communications sent to the hosted service 211 could be encrypted using the public key 109. Where multiple hosted services 211 are executed on the same host machine 201, multiple public keys 109 could be issued to the host machine 201.

Various applications or other functionality can also be executed by the management device 203. The components executed by the management device 203 can include a key management service 213. The management device 203 can also execute other applications, services, processes, systems, engines, or functionality not discussed in detail herein.

The key management service 213 can be executed to certify the ownership of individual keys. For example, the key management service 213 could generate and issue a new public private key pair in response to requests for new encryption keys. Key pairs could be issued for a limited duration of time, in which case the key management service 213 could further track the date the keys were issued in order to determine if they are still valid at a future point in time. The key management service 213 could also provide public keys associated with user, application, or machine in response to a request for the public key. The key management service 213 could also respond to queries regarding who a particular public key was issued to by the key management service 213 and/or if the public key is still valid (e.g., if it has expired or not). Other functionality could be included in the key management service 213, and various functions provided by the key management service 213 could be performed by separate applications.

The client device 206 is representative of any client devices 206 that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 219, such as liquid crystal displays (LCDs), gas plasma-based flat panel displays, organic light emitting diode (OLED) displays, electrophoretic ink (“E-ink”) displays, projectors, or other types of display devices. In some instances, the display 219 can be a component of the client device 206 or can be connected to the client device 206 through a wired or wireless connection.

The client device 206 can be configured to execute various applications such as a client application 223 or other applications. The client application 223 could be cause a user interface 226 to be rendered on the display 219. For example, the client application 223 can include a browser, a dedicated application, or other executable, and the user interface 226 can include a web page, an application screen, or other user mechanism for obtaining user input. Other examples of client applications 223 can include email applications, social networking applications, word processors, spreadsheets, or other applications.

A list of trusted contracts 229 can also be stored on the client device 206. The trusted contracts 229 can include a list blockchain addresses or identifiers for certifying contracts 106 that are trusted by the client device 206. The list of trusted contracts 229 could be initially populated with a default list of smart contracts. For example, a mobile device management (MDM) service or unified endpoint management (UEM) service could install on the client device 206 a list of approved smart contracts as trusted contracts 229. As another example, an end user could add the blockchain address of individual smart contracts that the user has personally decided to trust.

The blockchain network 100 represents a peer-to-peer network of nodes 233 that utilizes a consensus protocol to maintain an immutable, append only, eventually consistent data store such as a blockchain 236. In some implementations, the blockchain network 100 could be a permissioned blockchain network 100, where only authorized nodes 233 are permitted to join or participate in the blockchain network 100. Examples of permissioned blockchain networks include HYPERLEDGER FABRIC, QUOROM, and CORDA. In other implementations, the blockchain network 100 could be permissionless, where anyone is permitted to join the blockchain network 100. Examples of public or permissionless blockchain networks 100 include the BITCOIN network, the ETHEREUM network, the SOLANA network, etc.

Nodes 233 of the blockchain network 100 can represent computing devices and/or virtual machines that maintain a copy of the blockchain 236 and all transactions submitted to the blockchain network 100 for inclusion in the blockchain 236. In some blockchain networks 100, individual nodes 233 can perform specialized functions, such as creating or validating new blocks for the blockchain 236 (sometimes referred to as “mining”), storing a copy of the current state of the blockchain 236, responding to requests for the current state of the blockchain 236, etc. In other blockchain networks 00, one or more of these functions to be performed by the same node 233.

The blockchain 236 can represent an immutable, append only, eventually consistent distributed data store maintained by a plurality of nodes 233 in a peer-to-peer network that maintain duplicate copies of data stored in the blockchain 236. The nodes 233 of the blockchain network 100 can use a variety of consensus protocols to coordinate the writing of data written to the blockchain 236. In order to store data to the blockchain 236, such as a record of a transaction of cryptocurrency coins or tokens between wallet addresses, users can pay cryptocurrency coins or tokens to one or more of the nodes 233 of the blockchain 236. New data is written to the blockchain 236 in the form of blocks, with each block including the cryptographic hash of the previous block in the blockchain 236, thereby preventing tampering or altering of records stored in the blockchain 236.

Next, a general description of the operation of the various components of the network environment 200 is provided. Although the following description provides an example of the various interactions between the components of the network environment 100 according to the various embodiments of the present disclosure, other types of interactions are also encompassed by the various embodiments of the present disclosure. Additional information about specific sequences

To begin, once a public key 109 is issued, the key management service 213 could then store information about the public key 109 on the blockchain 236 of the blockchain network 100. For example, the key management service 213 could create an identity contract 103 for the public key 109 that was issued and publish the identity contract 103 to the blockchain 236. As another example, the key management service 213 could add an identity record 129 to an existing identity contract 103 on the blockchain 236. In addition, the key management service 213 could update a certifying contract 106 under its control to include a certification record 119 for the public key 109 issued for the network address 113 of the host machine 201.

Subsequently, a client application 223 executing on a client device 206 could attempt to connect to the hosted service 211 hosted at the network address 113 by the host machine 201. The application on the host machine 201 could present the public key 109 and/or a blockchain address of the identity contract 103 associated with the public key 109 for use with the application and the network address 113 of the host machine 201.

In response, the client application 223 could query the identity contract 103 associated with the network address 113 and the public key 109 to retrieve one or more certifying entities 116. The client application 223 could then compare the certifying entities 116 returned by the identity contract 103 with the list of trusted contracts 229. If any of the certifying entities 116 have a blockchain address that matches an entry in the list of trusted contracts 229, then the client application 223 could send a request to the trusted certifying contract 106 for the signature 126 of the public key 109 for the network address 113. The client application 223 could verify the signature 126 based at least in part on the public key 109 and the certifying public key 123 used to create the signature 126. If the signature for the public key 109 is valid, then the client application 223 can proceed to use the public key 109 for communications with the hosted service 211.

However, if none of the certifying entities 116 of the identity contract 103 are listed in the trusted contracts 229 of the client device 206, then other actions can be taken. For example, the client application 223 could recursively retrieve the certifying entities 116 for the certifying contracts 106 returned by the identity contract 103 until a certifying contract 106 that is listed in the trusted contracts 229 of the client device 206 is identified. If no certifying contract 106 is found that is included among the trusted contracts 229 of the client device 206, then the client application 223 may refuse to connect or communicate with the hosted service 211 or may prompt the user to affirmatively approve communications with the hosted service 211 in spite of the use of an untrusted public key 109.

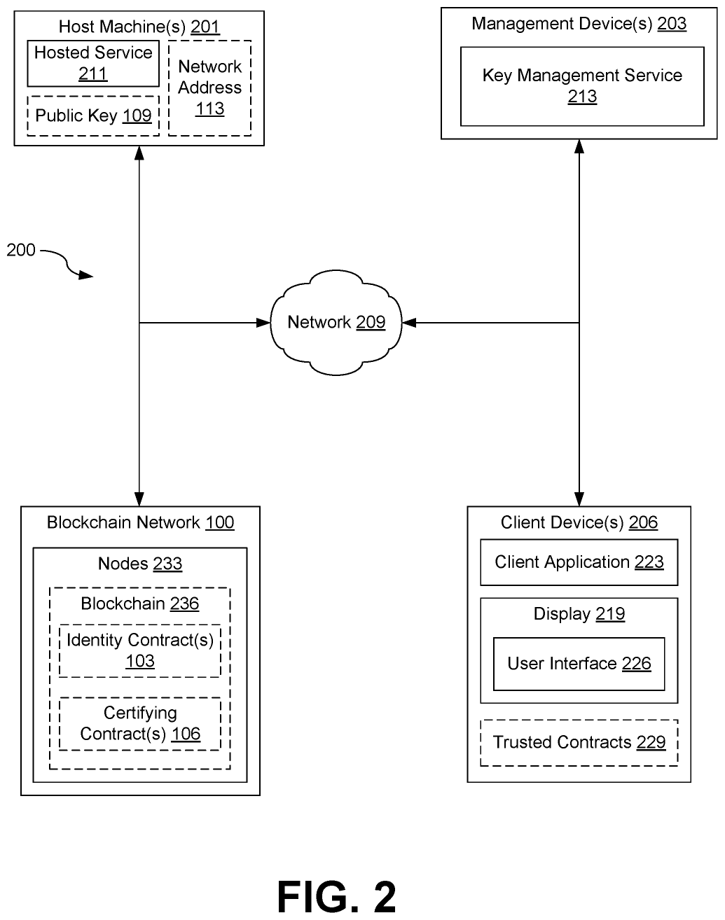

Referring next to FIG. 3, shown is a flowchart that provides one example of the operation of a portion of the client application 223. The flowchart of FIG. 3 provides merely an example of the many different types of functional arrangements that can be employed to implement the operation of the depicted portion of the client application 223. As an alternative, the flowchart of FIG. 3 can be viewed as depicting an example of elements of a method implemented within the network environment 200.

Beginning with block 303, the client application 223 can send a request to an identity contract 103 for a list of certifying entities 116 that have validated or certified the public key 109 associated with a specified network address 113. In some implementations, the client application 223 could call a function provided by the identity contract 103 that returns the list of certifying entities 116. In other implementations, the client application 223 could call a function and provide as arguments to the function the network address 113 and/or public key 109 specified by an identity record 129. In these implementations, the identity contract 103 could then return the certifying entities 116 stored in the respective identity record 129.

In some implementations, the client application 223 could authenticate with the identity contract 103 as part of the request process. For example, if the client application 223 included or was linked to a wallet address, the client application 223 could include its wallet address in the request to the identity contract 103 and a signature made with a respective private key for the wallet address of the client application 223. The identity contract 103 could then use the wallet address of the client application 223 and signature to determine whether the client application 223 was an approved client application 223 (e.g., by referencing a list of approved clients). If the client application 223 has a wallet address that is on a list of approve wallet addresses, the identity contract 103 could respond with the list of certifying entities 116.

Then, at block 306, the client application 223 can determine whether any of the blockchain addresses included in the list of certifying entities 116 match a blockchain address included in the list of trusted contracts 229 stored on the client device 206. If one or more of the blockchain addresses for a certifying contract 106 included in the list of certifying entities 116 match a blockchain address included in the list of trusted contracts 229, then the process can skip to block 319. However, if none of the blockchain addresses in the list of certifying entities 116 match a blockchain address in the list of trusted contracts 229, then the process can proceed to block 309.

Next, at block 309, the client application 223 can, for each certifying contract 106 identified by a blockchain address in the list of certifying entities 116, request the respective certifying entities 116 for each certifying contract 106. Referring back to FIG. 1A or FIG. 1B as a example, if neither certifying contract 106a nor certifying contract 106b were listed among the trusted contracts 229, then the client application 223 could invoke a function call provided by certifying contract 106a to retrieve the list of certifying entities 116 stored by certifying contract 106a, which would return a blockchain address for certifying contract 106c among other potential certifying contracts 106. The client application 223 could also separately invoke a function call provided by certifying contract 106b to retrieve the list of certifying entities 116 stored by certifying contract 106b.

In some implementations, the client application 223 could authenticate with the certifying contracts 106 as part of the request process. For example, if the client application 223 included or was linked to a wallet address, the client application 223 could include its wallet address in the request to the certifying contract 106 and a signature made with a respective private key for the wallet address of the client application 223. Each certifying contract 106 could then use the wallet address of the client application 223 and signature to determine whether the client application 223 was an approved client application 223 (e.g., by referencing a list of approved clients). If the client application 223 has a wallet address that is on a list of approve wallet addresses, each certifying contract 106 could respond with the list of certifying entities 116.

Moving on to block 313, the client application 223 can determine whether any of the blockchain addresses included in the list of certifying entities 116 retrieved at block 309 match a blockchain address included in the list of trusted contracts 229 stored on the client device 206. If one or more of the blockchain addresses for a certifying contract 106 included in the list of certifying entities 116 match a blockchain address included in the list of trusted contracts 229, then the process can proceed to block 316. However, if none of the blockchain addresses in the list of certifying entities 116 match a blockchain address in the list of trusted contracts 229, then the process can return back to block 309 in order to retrieve additional certifying entities 116. For example, if the certifying contract 106c were not included among the trusted contracts 229 of the client device 206, then the process could return to block 309 in order to recursively retrieve the certifying entities 116 of the certifying contract 106c for subsequent evaluation. Although not illustrated in FIG. 3, the client application 223 can be configured for performance reasons to stop repeatedly requesting additional certifying entities 116 if certifying contracts 106 are found that are listed among the trusted contracts 229 of the client device 206. In these situations, the depicted process could end.

Proceeding to block 316, the client application 223 can recursively verify the certifying public keys 123 of the certifying contracts 106 identified. Referring to FIG. 1A and FIG. 1B as examples, if the client application 223 had determined that certifying contract 106c was among the trusted contracts 229 of the client device 206, then the client application 223 could request the signature 126c from the certification 119c for the certifying public key 123a of the certifying contract 106a. The client application 223 could then use the certifying public key 123c to verify the signature 126c. If there were additional certifying contracts in the chain between the identity contract 103 and the trusted certifying contract 106c, then the same process could be recursively performed for each additional certifying contract 106 until all of the certifying contracts 106 between the identity contract 103 and the certifying contract 106c had been verified or validated.

Then, at block 319, the client application 223 can determine whether there is a signature of the public key 109. To use FIG. 1A and FIG. 1B as examples, the client application 223 could determine whether there is a signature 126a for the public key 109 in a certification 119a. This could be done by requesting the signature 126a by invoking or calling a function of the certifying contract 106a using the network address 113 of the public key 109 as an argument. The certifying contract 106a could then return a signature 126a for the public key 109. If no certification 119a exists for the network address 113, which could happen if the public key 109 if the certification 119a for the public key 109 had been revoked, then nothing would be returned. If a signature 126a for the public key 109 is returned, then the process can proceed to block 323. If no signature 126a is returned, which could indicate that a key revocation event had occurred, then the process could end.

Subsequently, at block 323, the client application 223 can verify the signature 126a for the public key 109. For example, the client application 223 could call a function provided by the certifying contract 106a to obtain the certifying public key 123a of the certifying contract 106a. The client application 223 could then use the certifying public key 123a to verify the signature 126a of the public key 109. If the signature 126a is valid, then the client application 223 can use the public key 109 to communicate with the host service 211. However, if the signature 126a is invalid, this could indicate that the public key 109 is invalid or has been revoked, and the process would end.

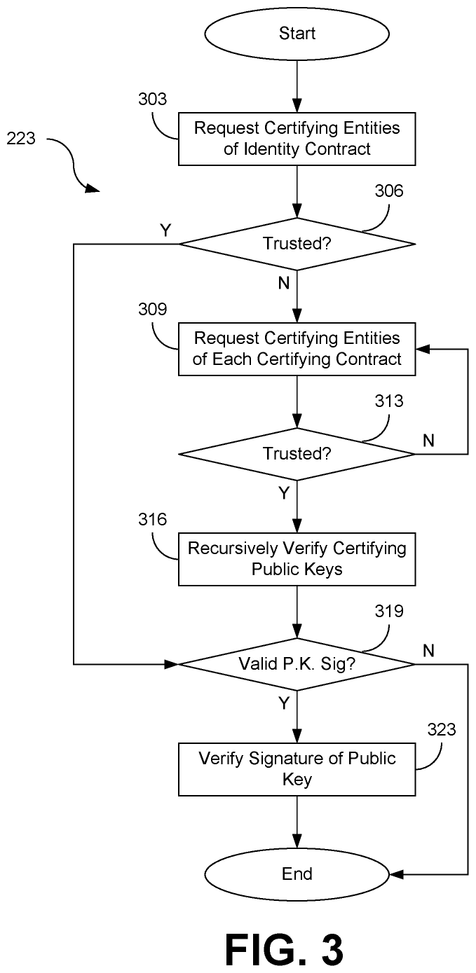

FIG. 4 depicts a graphical representation of a web of certifying contracts 106 that would be traversed by the process described in FIG. 3 to build a chain of trust between a trusted certifying contract 106 and the identity contract 103 storing the public key 109 for use in communications with a hosted service 211 at a network address 113. Certifying contracts 106 that are trusted are depicted in solid lines in FIG. 4 for illustrative purposes, while untrusted certifying contracts 106 are depicted in dashed lines.

As shown, the identity contract 103 has two certifying entities 116, the certifying contract 106a and the certifying contract 106b. Although the certifying contract 106b may not have any additional certifying entities 116, the certifying contract 106a has the certifying contract 106c as a certifying entity 116. The certifying contract 106c has certifying contracts 106d and 106e as certifying entities 116. Although the certifying contract 106e has no additional certifying entities 116, the certifying contract 106d has certifying contract 106f as a certifying entity 116. These relationships could be recursively discovered by the client application 223 through repeated requests for the next level of certifying entities 116, as previously described in FIG. 3. Once the client application 223 identifies certifying contract 106f as a trusted contract 229, the client application 223 can verify that the certifying contract 106d has been certified by the certifying contract 106f and can therefore be trusted. Likewise, now that the certifying contract 106d has been determined to be trustworthy, the client application 223 can verify that the certifying contract 106dc has been certified by the certifying contract 106d and can therefore be trusted. The same process can be repeated for certifying contract 106a and the identity contract 103 to establish a chain of trust, whereby the client application 223 may not initially trust the identity contract 103 or the certifying contract 106a, but can establish their trustworthiness due to their ultimate connection with the trusted certifying contract 106f.

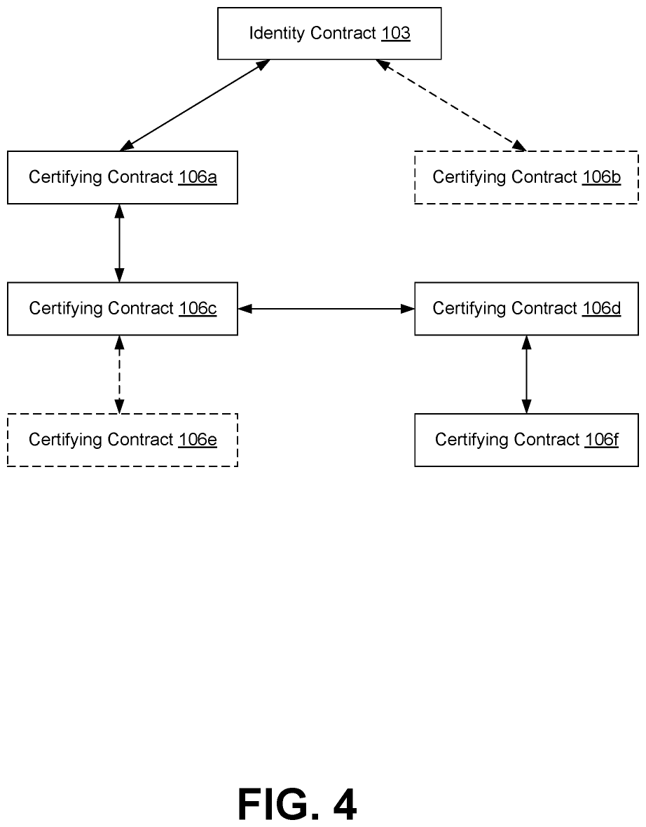

Referring next to FIG. 5, shown is a flowchart that provides one example of the operation of a portion of the key management service 213. The flowchart of FIG. 5 provides merely an example of the many different types of functional arrangements that can be employed to implement the operation of the depicted portion of the key management service 213. As an alternative, the flowchart of FIG. 5 can be viewed as depicting an example of elements of a method implemented within the network environment 200.

Beginning with block 503, the key management service 213 can issue a public key 109 and a respective private key to a requesting entity, organization, or individual. Key requests could be submitted in response to a variety of events. For example, a key request could be submitted because a new public key 109 and private key need to be issued for a newly commissioned or deployed host machine 201 or hosted service 211. As another example, a key request could be submitted because a previously issued public key 109 and private key need to be replaced (e.g., because previously issued keys have expired or have been revoked to a security compromise). The request could be manually submitted (e.g., by an individual through a webform) or automatically submitted (e.g., by a host machine 201 or hosted service 211 sending an automated request for a public key 109 and private key). The request could include information such as the network address 113 for the host machine 201 or hosted service 211. In response to the request, the key management service 213 can generate a public-private key pair that contains the public key 109 and a respective private key. The public key 109 and respective private key can be returned to the requesting individual, entity, or host machine 201 or hosted service 211.

Then, at block 506, the key management service 213 can either publish a new identity contract 103 or update an existing identity contract 103 to include information related to the public key 109 issued at block 503. For example, if a public key 109 had not been previously issued for a network address 113, a new identity contract 103 could be created for the public key 109 and network address 113. Alternatively, a new identity record 129 could for the public key 109 and network address 113 could be created and added to an existing identity contract 103.

However, if an identity contract 103 already exists for the network address 113, such as when a public key 109 has been previously issued, then key management service 213 could instead invoke or call a function provided by the identity contract 103 to replace the previously stored public key 109 with the newly issued public key 109. Similarly, if an identity record 129 already exists for the network address 113, then the key management service 213 could invoke or call a function provided by the identity contract 103 to replace the previously stored public key 109 in the identity record 129 for the network address 113 with the newly issued public key 109.

Subsequently, at block 509, the key management service 213 can publish a new certifying contract 106 or update an existing certifying contract 106. A new certifying contract 106 could be published and a certification 119 added if this were the first public key 109 issued by the key management service 213. Otherwise, the key management service 213 could update an existing or newly published certifying contract 106 to include a certification 119 of the public key 109. For example, the key management service 213 could invoke or call a function of the certifying contract 106 and provide the public key 109 to the certifying contract 106. In response, the certifying contract 106 could use a respective private key for the certifying public key 123 of the certifying contract 106 to generate a signature 126. The certifying contract 106 could then add new certification 119 for the public key 109 to the certifications 119 maintained by the certifying contract 106. Once the certification 119 is created, an acknowledgement could be returned by the certifying contract 106 to the key management service 213.

Once a certification 119 is added to the certifying contract 106 at block 509, then, at block 513, the key management service 213 can add the blockchain address to the list of certifying entities 116 associated with the identity contract 103 or identity record 129 of the public key 109. For example, the key management service 213 could invoke or call a function provided by the identity contract 103, and provide both the public key 109 (or an identifier for the public key 109) and the blockchain address of the certifying contract 106.

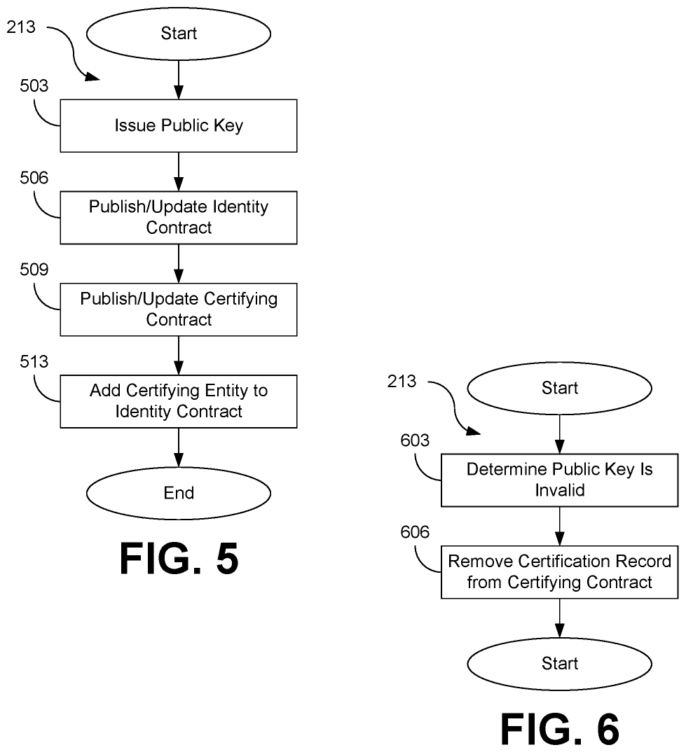

Referring next to FIG. 6, shown is a flowchart that provides one example of the operation of a portion of the key management service 213. The flowchart of FIG. 5 provides merely an example of the many different types of functional arrangements that can be employed to implement the operation of the depicted portion of the key management service 213. As an alternative, the flowchart of FIG. 6 can be viewed as depicting an example of elements of a method implemented within the network environment 200.

Beginning with block 603, the key management service 213 can determine whether a public key 109 is no longer valid. This could be done using a variety of approaches. For example, the key management service 213 could receive a key revocation request from the individual or organization to whom a public key 109 was issued. A key revocation request could be received, for example in response to a security breach or security compromise of the public key 109 or its respective private key. As another example, the key management service 213 could determine that a public key 109 that had been previously issued has since expired if an expiration date had been set for the public key 109 at the time of its creation. Other approaches to identify revoked or expired public keys 109 could also be used by various embodiments of the present disclosure.

Then, at block 606, the key management service 213 could remove the certification 119 for the public key 109 from the certifying contract 106 associated with the key management service 213. For example, the key management service 213 could invoke or call a function provided by the certifying contract 106, and provide the public key 109 (or an identifier of the public key 109) as an argument to the function. In some implementations, the key management service 213 could be associated with a wallet address, and the key management service 213 could include its wallet address and a signature generated by the respective private key for the wallet address in order to authenticate with the certifying contract 106. In response to the function call, the certifying contract 106 could verify that the key management service 213 is permitted to remove or modify certifications 119 maintained by the certifying contract 106 and then remove the certification 119 for the specified public key 109.

As a result of removing a certification 119 for a public key 109, a client application 223 is unable to verify the signature 126 for the public key 109. Therefore, the client application 223 is unable to determine if the public key 109 is valid and, in many implementations, could be configured to not to use a public key 109 that is not signed by a certifying contract 106.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain, from an identity smart contract hosted by a blockchain network, a public key associated with a network address and an identifier of a certifying smart contract for a certifying entity associated with the public key;
obtain, from the certifying smart contract, a certifying public key and a signature for the public key associated with the network address; and
verify the signature of the public key associated with the network address using the certifying public key.

2. The system of claim 1, wherein the certifying smart contract is a first certifying smart contract, the certifying entity is a first certifying entity, the certifying public key is a first certifying public key, the signature is a first signature, the identifier is a first identifier, and the machine-readable instructions further cause the computing device to at least:
obtain, from the certifying smart contract, a second identifier for a second certifying smart contract for a second certifying entity associated with the first certifying public key;
obtain, from the second certifying smart contract, a second certifying public key and a second signature for the first certifying public key associated with the first certifying smart contract; and
verify the second signature of the first certifying public key using the second certifying public key.

3. The system of claim 1, wherein the machine-readable instructions further cause the computing device to at least authenticate with the identity smart contract prior to obtaining the public key associated with the network address and the identifier of the certifying smart contract for the certifying entity associated with the public key.

4. The system of claim 1, wherein the machine-readable instructions further cause the computing device to at least authenticate with the certifying smart contract prior to obtaining the certifying public key and the signature for the public key associated with the network address.

5. The system of claim 1, wherein the machine-readable instructions further cause the computing device to at least encrypt communications with a host service located at the network address using the public key.

6. The system of claim 1, wherein the blockchain network is a permissioned blockchain network.

7. The system of claim 1, wherein the identifier of the certifying smart contract comprises a blockchain name service address.

8. A method, comprising:
obtaining, from an identity smart contract hosted by a blockchain network, a public key associated with a network address and an identifier of a certifying smart contract for a certifying entity associated with the public key;
obtaining, from the certifying smart contract, a certifying public key and a signature for the public key associated with the network address; and
verifying the signature of the public key associated with the network address using the certifying public key.

9. The method of claim 8, wherein the certifying smart contract is a first certifying smart contract, the certifying entity is a first certifying entity, the certifying public key is a first certifying public key, the signature is a first signature, the identifier is a first identifier, and the method further comprises:
obtaining, from the certifying smart contract, a second identifier for a second certifying smart contract for a second certifying entity associated with the first certifying public key;
obtaining, from the second certifying smart contract, a second certifying public key and a second signature for the first certifying public key associated with the first certifying smart contract; and
verifying the second signature of the first certifying public key using the second certifying public key.

10. The method of claim 8, further comprising authenticating with the identity smart contract prior to obtaining the public key associated with the network address and the identifier of the certifying smart contract for the certifying entity associated with the public key.

11. The method of claim 8, further comprising authenticating with the certifying smart contract prior to obtaining the certifying public key and the signature for the public key associated with the network address.

12. The method of claim 8, further comprising encrypting communications with a host service located at the network address using the public key.

13. The method of claim 8, wherein the blockchain network is a permissioned blockchain network.

14. The method of claim 8, wherein the identifier of the certifying smart contract comprises a blockchain name service address.

15. A non-transitory, computer-readable medium, comprising machine-readable instructions that, when executed by a processor of a computing device, cause the computing device to at least:
obtain, from an identity smart contract hosted by a blockchain network, a public key associated with a network address and an identifier of a certifying smart contract for a certifying entity associated with the public key;
obtain, from the certifying smart contract, a certifying public key and a signature for the public key associated with the network address; and
verify the signature of the public key associated with the network address using the certifying public key.

16. The non-transitory, computer-readable medium of claim 15, wherein the certifying smart contract is a first certifying smart contract, the certifying entity is a first certifying entity, the certifying public key is a first certifying public key, the signature is a first signature, the identifier is a first identifier, and the machine-readable instructions further cause the computing device to at least:
obtain, from the certifying smart contract, a second identifier for a second certifying smart contract for a second certifying entity associated with the first certifying public key;
obtain, from the second certifying smart contract, a second certifying public key and a second signature for the first certifying public key associated with the first certifying smart contract; and
verify the second signature of the first certifying public key using the second certifying public key.

17. The non-transitory, computer-readable medium of claim 15, wherein the machine-readable instructions further cause the computing device to at least authenticate with the identity smart contract prior to obtaining the public key associated with the network address and the identifier of the certifying smart contract for the certifying entity associated with the public key.

18. The non-transitory, computer-readable medium of claim 15, wherein the machine-readable instructions further cause the computing device to at least authenticate with the certifying smart contract prior to obtaining the certifying public key and the signature for the public key associated with the network address.

19. The non-transitory, computer-readable medium of claim 15, wherein the blockchain network is a permissioned blockchain network.

20. The non-transitory, computer-readable medium of claim 15, wherein the identifier of the certifying smart contract comprises a blockchain name service address.
